(19) United States
(12) Patent Application Publication
(10) Pub. No.: US 2014/0092255 A1
(43) Pub. Date: Apr. 3, 2014

(54) AUTO CORRELATION BETWEEN CAMERA BANDS

(71) Applicant: BAE Systems Information and Electronic Systems Integration Inc., Nashua, NH (US)

(72) Inventors: Michael J. Choiniere, Merrimack, NH (US); Mark R. Mallalieu, Westford, MA (US)

(73) Assignee: BAE Systems Information and Electronic Systems Integration Inc., Nashua, NH (US)

(21) Appl. No.: 14/045,068

(22) Filed: Oct. 3, 2013

Related U.S. Application Data
(60) Provisional application No. 61/744,763, filed on Oct. 3, 2012.

(51) Int. Cl. G06T 7/00

(52) U.S. Cl. CPC G06T 7/0018
USPC 348/164

(57) ABSTRACT

A method for correlating an image to align two sensors comprising the steps of centering an imaging unit on a landmark that provides good contrast and distinct edges so as to provide a scene, taking a snapshot of the scene from both sensors, applying a Sobel edge filter to the image from both sensors to create two strong edge maps, cropping a small block of one image centered about the landmark and cross-correlating it on a larger region centered on an expected position of the landmark in the other image, and from the position of the strongest correlation peak determining the position of the center of the block from the first image, providing the difference in the alignment of the two sensors.

### CROSS-REFERENCE TO RELATED APPLICATIONS

This Application claims rights under 35 USC §119(e) from U.S. Application Ser. No. 61/744,763 filed Oct. 3, 2012, and this application is related to application Ser. No. 61/660,117 (docket 12-2946) filed Jun. 15, 2012 and entitled “MODULAR AVAM WITH OPTICAL AUTOMATIC ATTITUDE MEASUREMENT” and application Ser. No. 61/703,405 (docket BAEP-1268) filed Sep. 20, 2012 and entitled “RATE AIDED IMAGE REGISTRATION”, both of which are assignable to the assignee to this application and are incorporated herein by reference. This application is also assigned to application Ser. No. ______ (docket BAEP-1768) entitled “SCENE CORRELATION” and application Ser. No. ______ (docket BAEP-1770) entitled “STACKING CONNECTOR FOR MILITARY APPLICATIONS”, both of which are filed on even date herewith and are assignable to the assignee of this application and are incorporated herein by reference.

### BACKGROUND OF THE INVENTION

1. Field of the Invention

The present invention is related to optical systems and more particularly to targeting systems for military applications.

2. Brief Description of Related Art

In targeting systems there are typically multiple cameras, and are all held to a boresight condition using mechanics within the sight itself. These cameras have to be held in this way over time, during temperature changes, and while experiencing shock and vibration.

A need, therefore, exists for an improved way of maintaining boresight of the cameras in such targeting systems.

### SUMMARY OF THE INVENTION

According to the invention digital imagery from all the camera bands is used to generate Sobels so that when the cameras look at the same scene the images are correlated between the bands so that the cameras may be boresighted in real time. In addition to that feature, the SWIR camera possesses the ability to see all lasers so when we see the lasers such as the laser marker and the laser range finder, we can see the laser within the SWIR imagery. When the laser hits relative to the imagery, we can correlate it to a visible band and a LWIR band as well.

### BRIEF DESCRIPTION OF THE DRAWINGS

The present invention is further described with reference to the accompanying drawings wherein:

FIG. 1 is a series of photographs aligning LWIR and SWIR sensors;

FIG. 2 is a series of photographs co-aligning visible and SWIR sensors;

FIG. 3 is a series of photographs co-aligning visible and SWIR sensors;

FIG. 4 is a series of photographs co-aligning visible and SWIR sensors;

FIG. 5 is a series of photographs aligning LWIR, SWIR and visible light;

FIG. 6 is a series of photographs aligning LWIR and SWIR;

FIG. 7 is a series of photographs aligning LWIR and visible light;

FIG. 8 is a series of photographs aligning LWIR and SWIR/visible light;

FIG. 9 is a series of photographs aligning LWIR with SWIR/visible light;

FIG. 10 is a series of photographs aligning SWIR and visible light with natural scenery;

FIG. 11 is a series of photographs aligning SWIR and visible light with natural scenery;

FIG. 12 is a series of photographs aligning LWIR and SWIR/visible light with natural scenery;

FIG. 13 is a series of photographs aligning LWIR and SWIR/visible light with natural scenery;

FIG. 14 is a table showing conclusions; and

FIG. 15 is a schematic drawing showing processing architecture for scene correlations for sensor alignment.

### DETAILED DESCRIPTION OF THE INVENTION

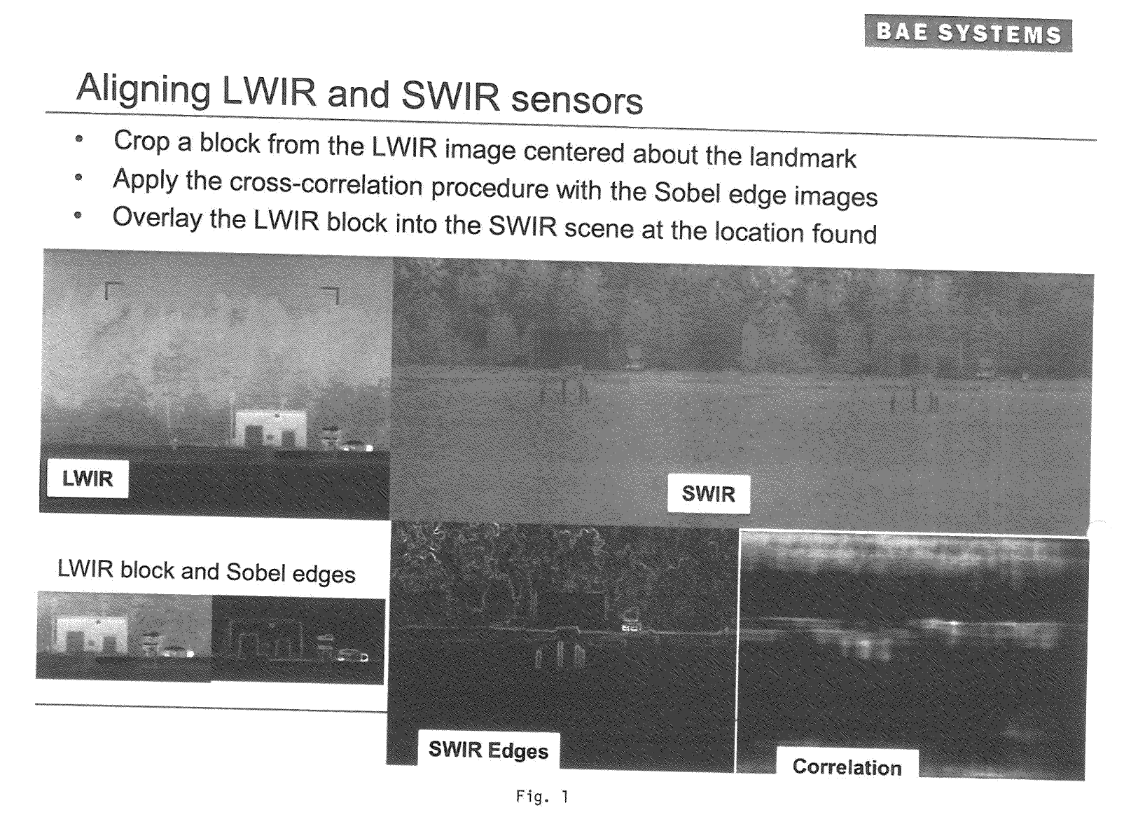

FIG. 1 shows an LWIR imagery in the upper left corner and a SWIR band imagery. We do the Sobels which are the line drawings beneath each of the drawings and then we can move them relative to each other and find a maximum correlation which is the lower right picture. The correlation shows a very bright dot which is actually a very high correlated, very spiky type correlation. Typically we can hold about a pixel performance. The upper right picture is the result of taking the LWIR and superimposing it on SWIR, so that a red image on top of the black and white results which provides a sense of how well we align the imagery as is shown, when successful, when all the lines are nice and crisp and everything is lined up quite well.

A “Sobel” is a line drawing which enables on to take any camera imagery and generate a line drawing of each of the pictures and that is what we use for alignment.

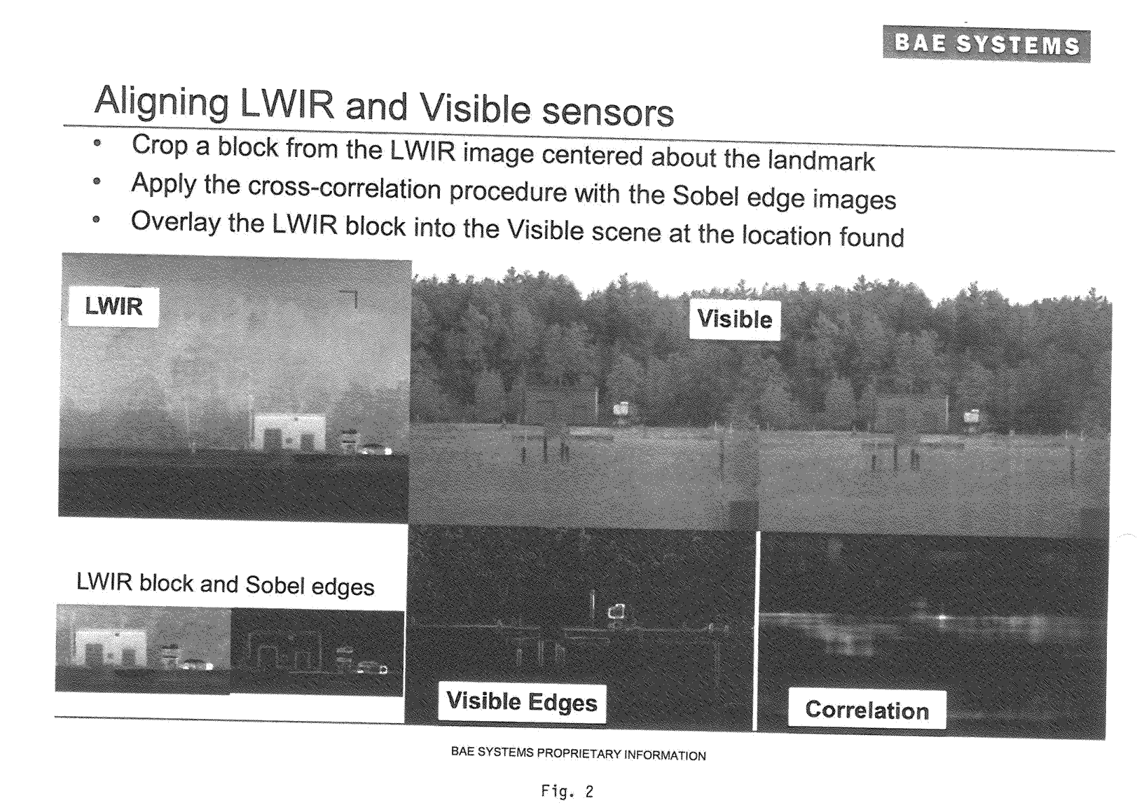

FIG. 2 is the same process again recording a LWIR to a visible. We take the Sobels of both the LWIR and visible and line them up to generate a correlation in the lower right and then we superimpose them on the LWIR on top of visible. Again what is seen is a very aligned picture with no fuzziness, has crisp edges, and a very good alignment.

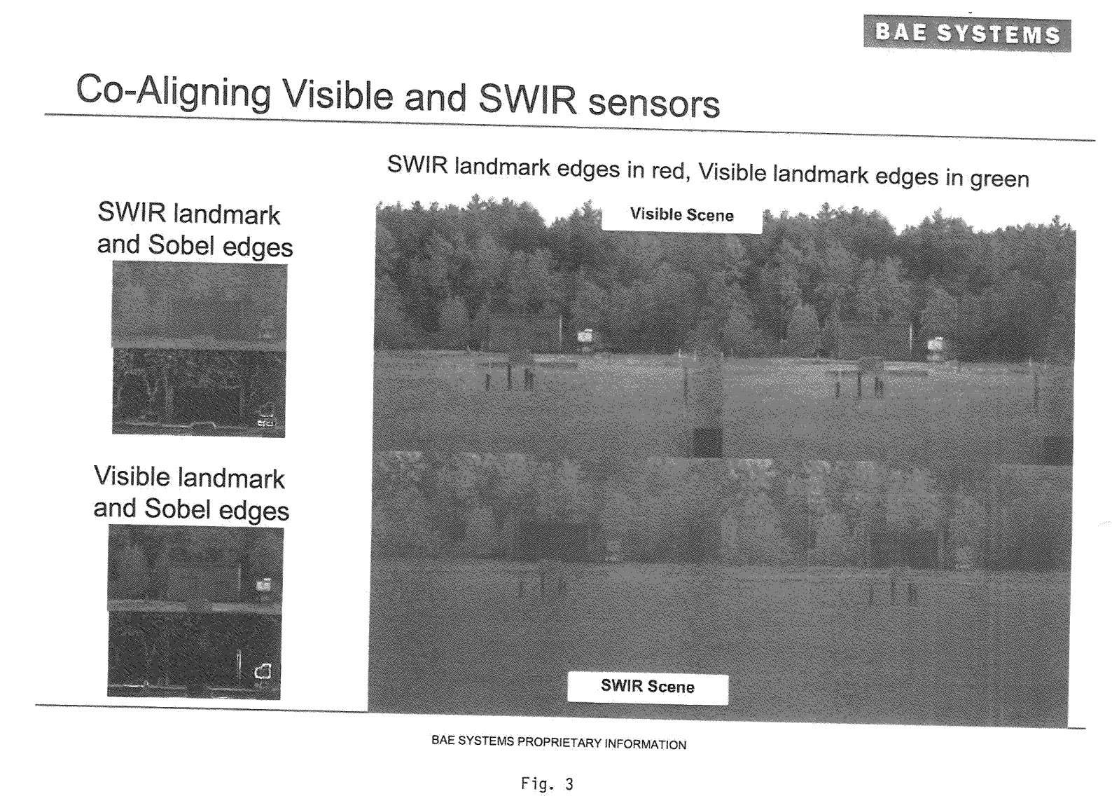

FIG. 3 shows the SWIR to visible so we can go through all the different bands unto each other. We generate the Sobels again and this time we put visible on SWIR and SWIR on visible. Again the line edges are very exact to the geometric figures in the picture.

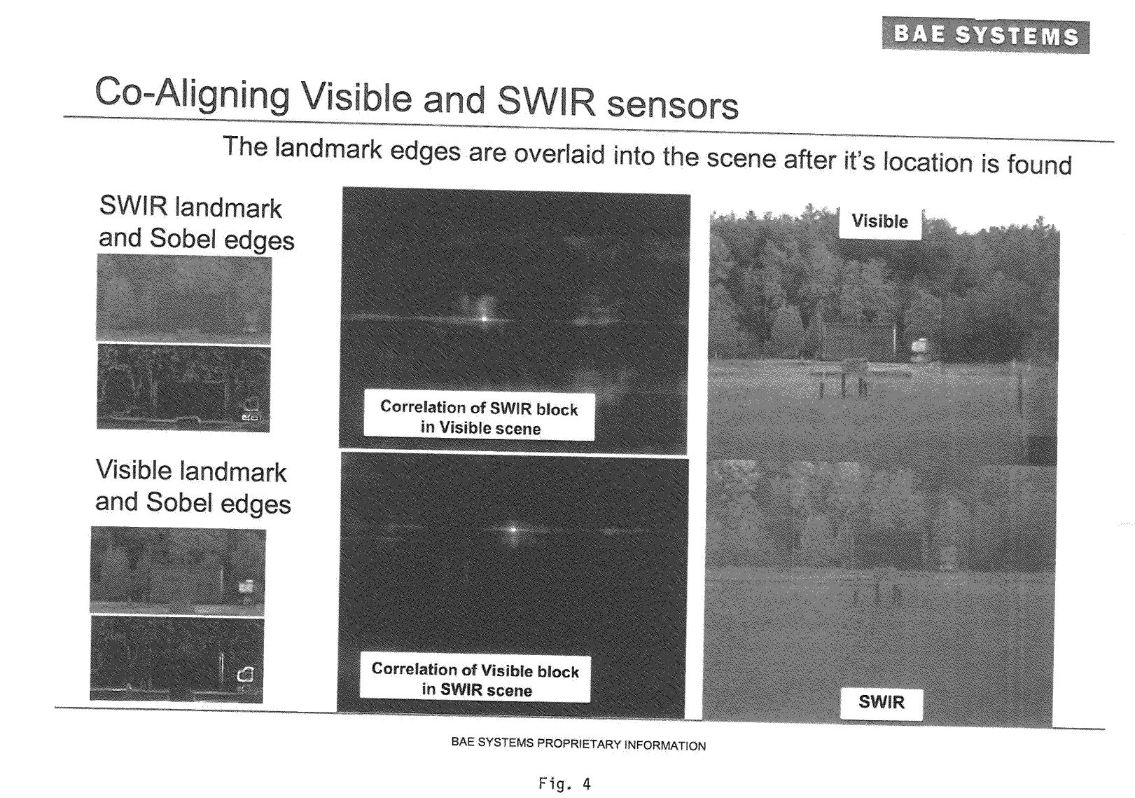

FIG. 4 shows the co-aligning of visible to SWIR sensors so again the Sobels generate the maximization correlation and are then superimposed on top of each other.

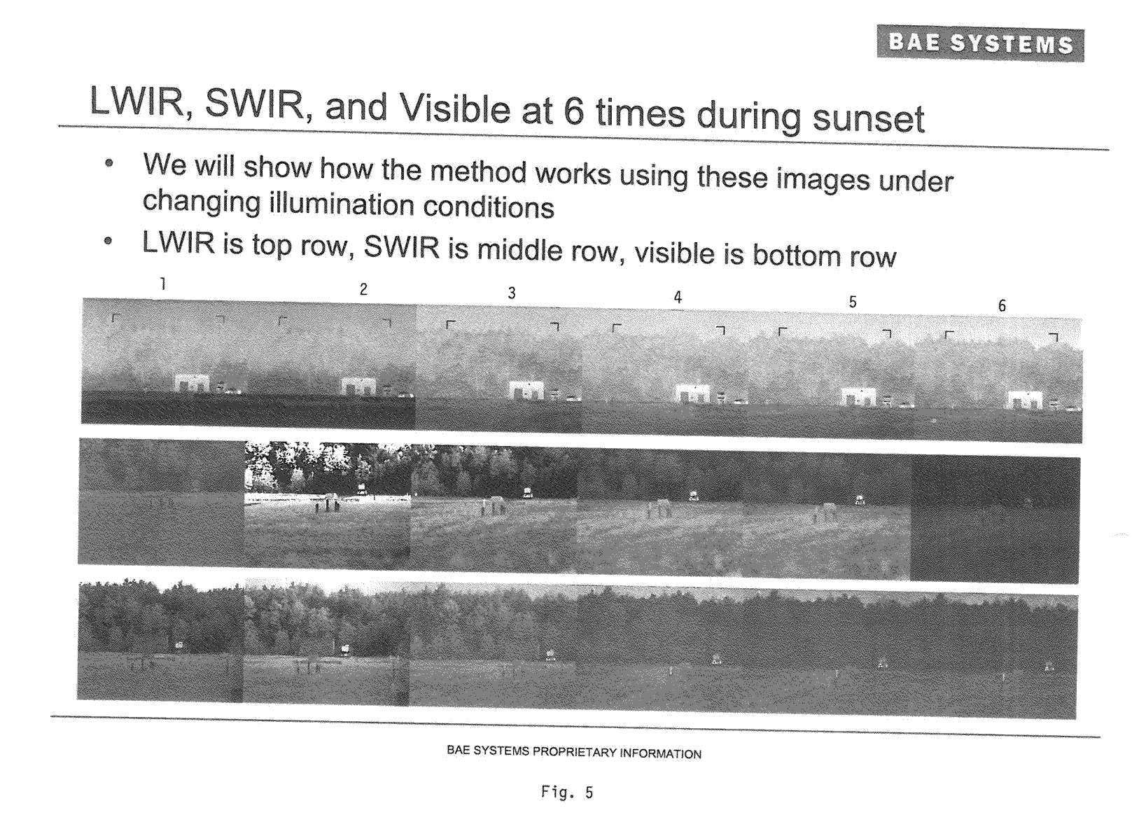

FIG. 5 shows time exposures during the day under very different lighting conditions. As one runs his eye over each of the rows, it can be seen how the lighting and the exposures of the frame are all different and provide different contrasts within the scene. The Sobels operates on contrast changes/edges within the scene; although the appearance changes, the edges remain the same.

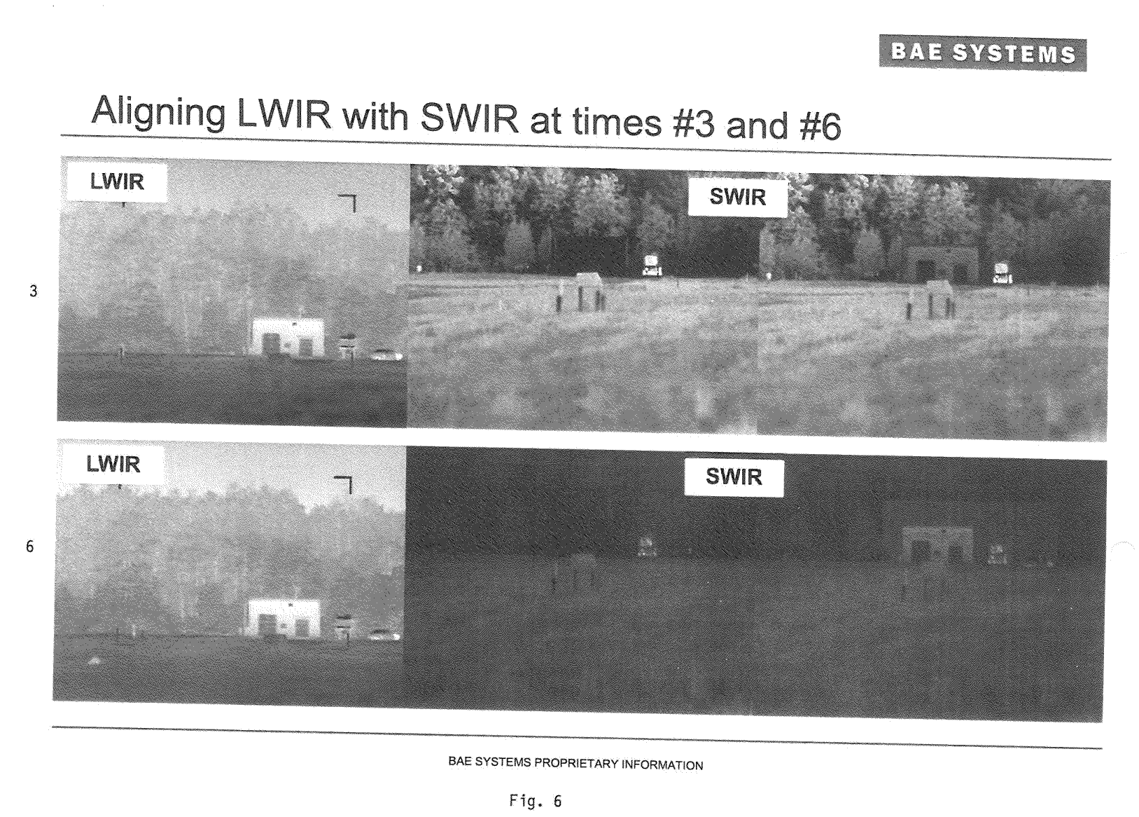

FIG. 6 shows the result of taking lines 3 and 6 of the lines from FIG. 5 and zooming in on those lines. It also shows how well the alignment actually holds and in this case it is LWIR to SWIR and the alignment is preserved in both.

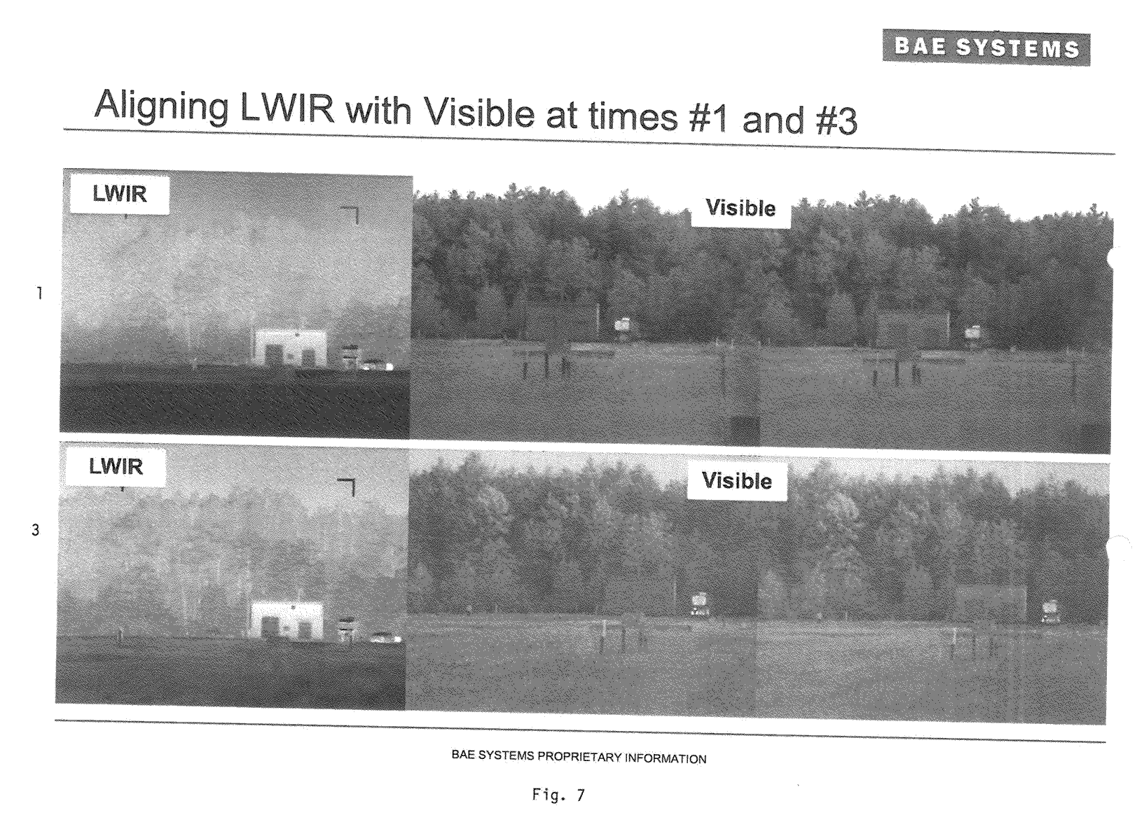

FIG. 7 shows the result of taking basically frames 1 and 3 from FIG. 5 and again showing LWIR and visible working relative to each other and how well the alignment holds.

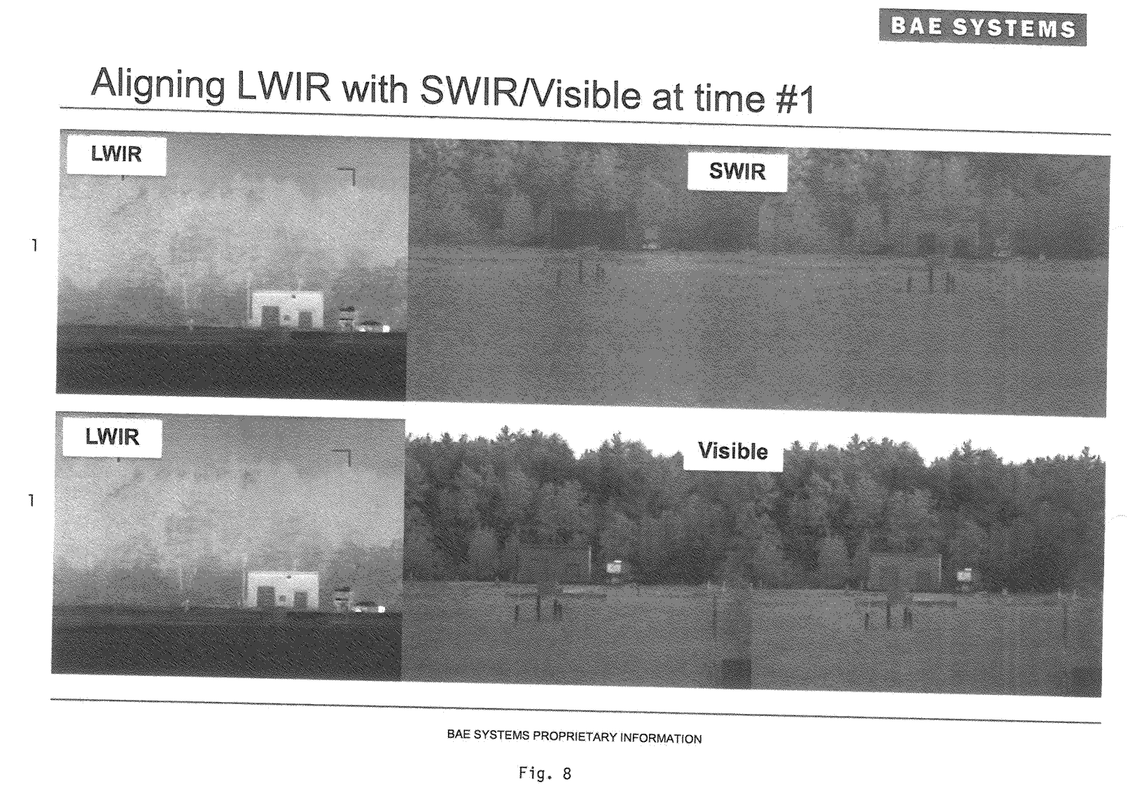

FIG. 8 is basically an alignment of LWIRs SWIR visible at a time so we have LWIR and SWIR, LWIR and visible. Again, we show how well the alignment works at this point.

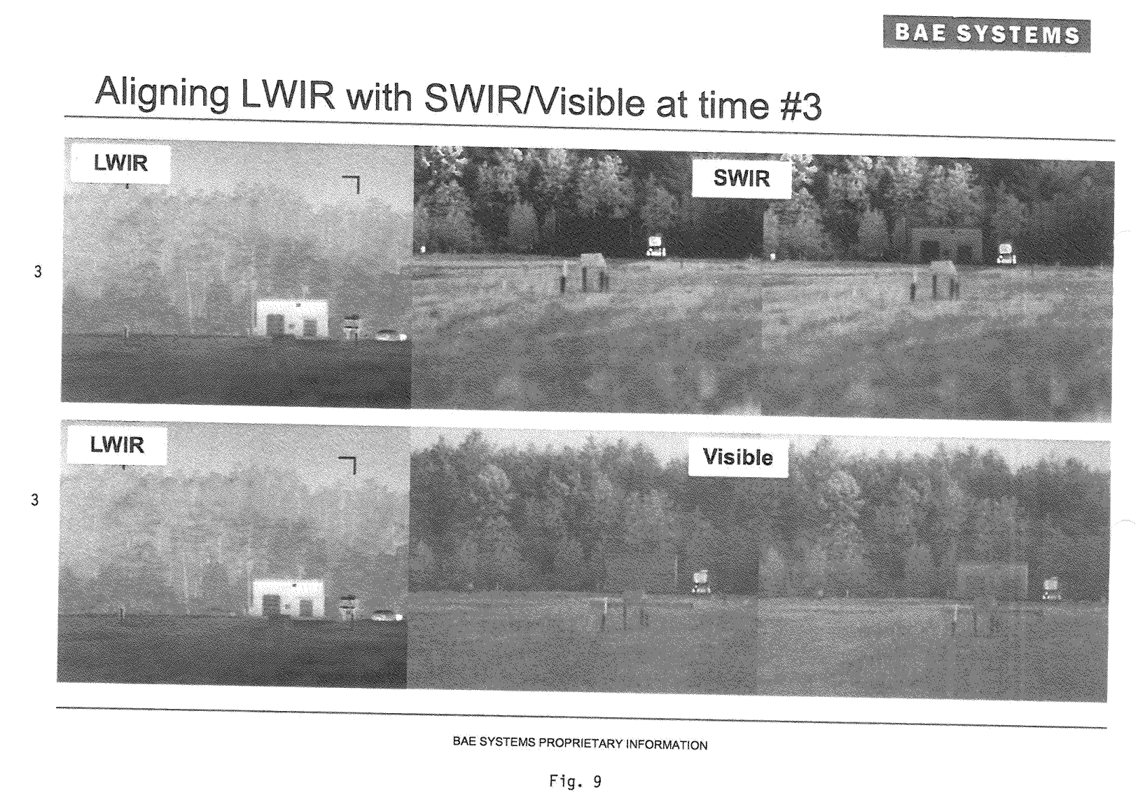

FIG. 9 shows the result of taking line 3 from FIG. 5 and aligning LWIRs as SWIR and visible and shows the overlays on how well they actually work.

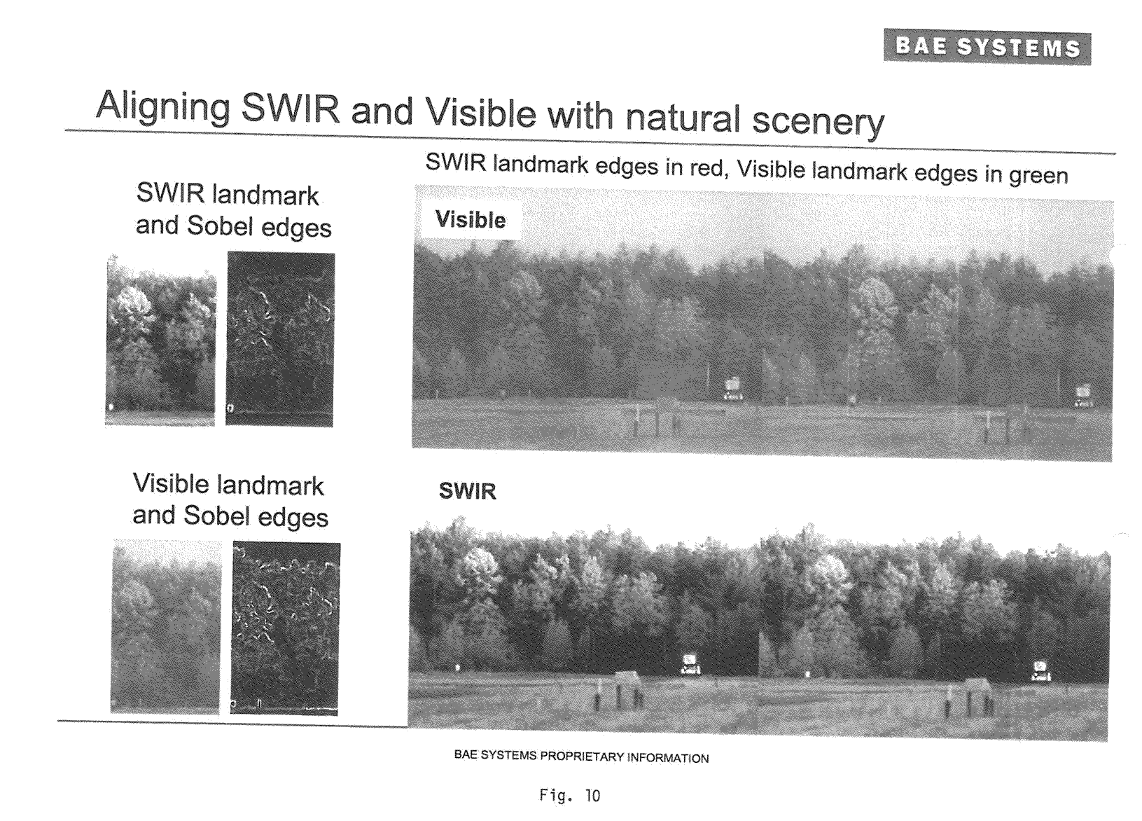

FIG. 10 shows an experiment to show we do not need geometric figures or man-made edges such as sharp lines. We can actually work on treelines. In this case we looked at SWIR relative to visible, and we specifically targeted just the Sobels on the treelines to show that any features can be correlated.

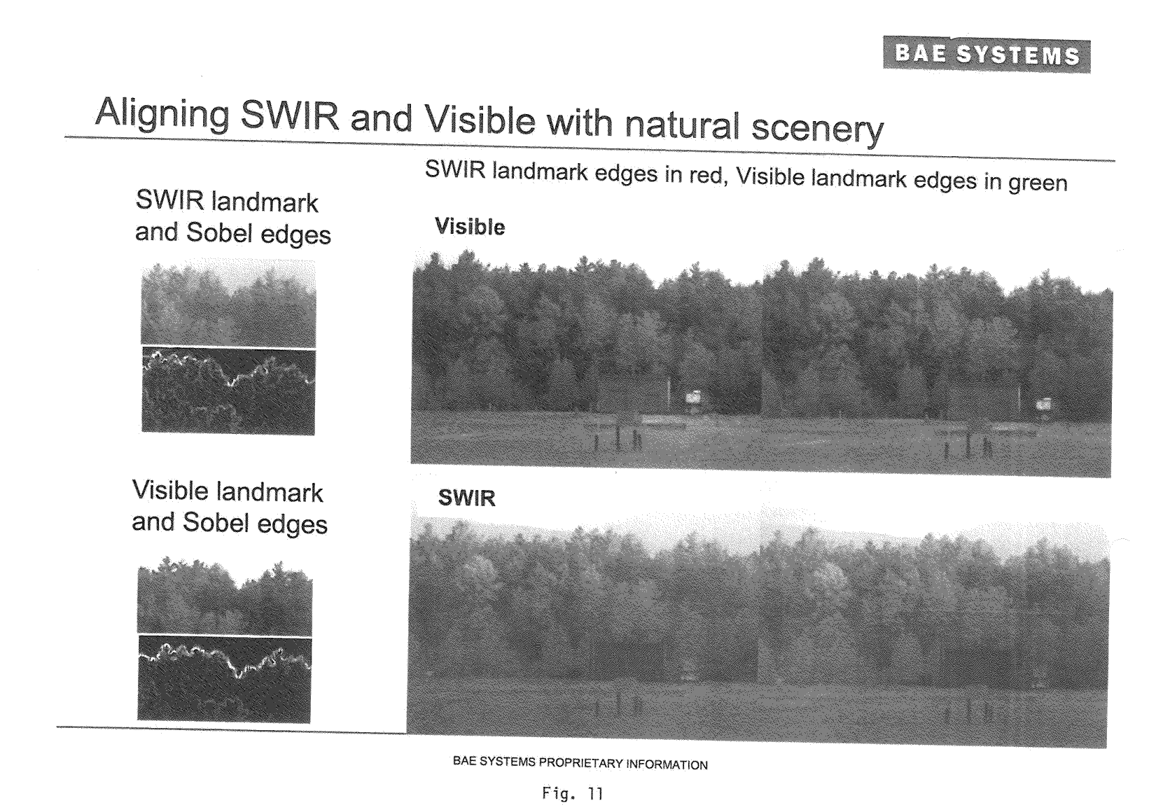

FIG. 11 shows the same experiment as shown in FIG. 10, but this time showing SWIR and visible with natural scenery. We targeted treelines which have a mixture of sky imagery as well the top of the treelines and natural scenery. This photograph demonstrates that the imagery can be registered.

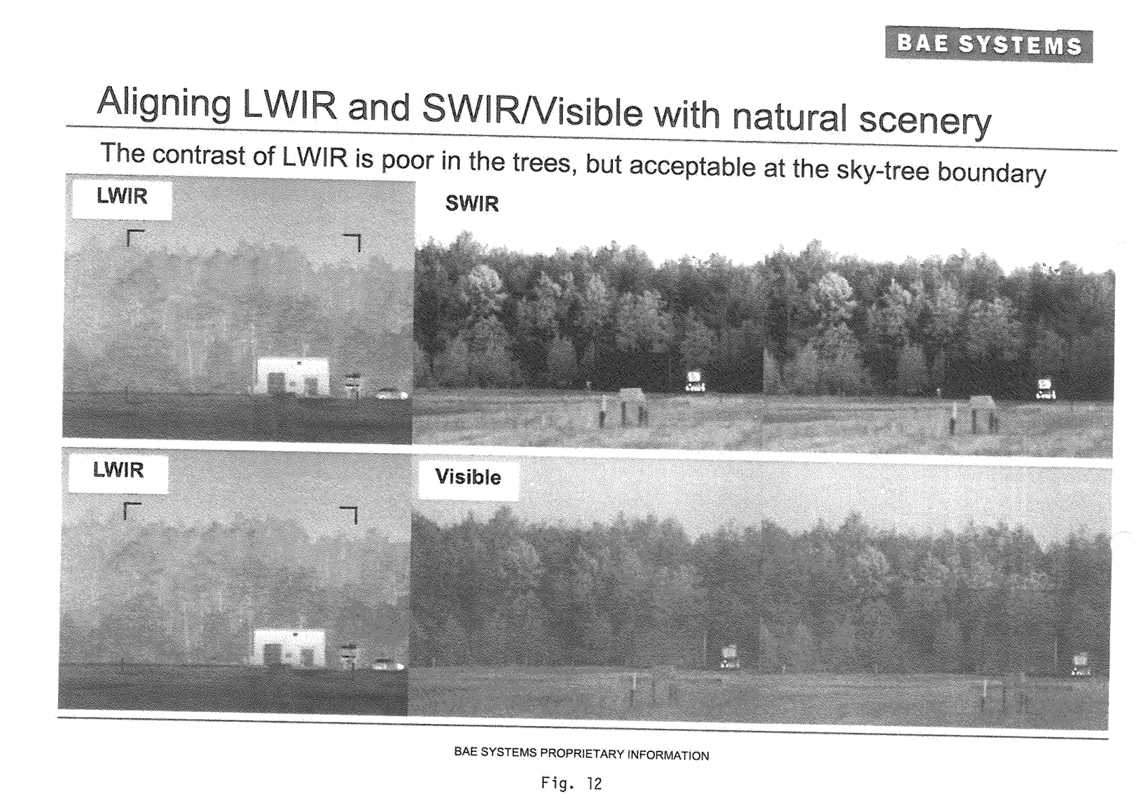

FIG. 12 is a repeat of the natural scenery experiment using LWIR, SWIR and visible with the LWIR and SWIR and LWIR and visible. Again, registration was accomplished.

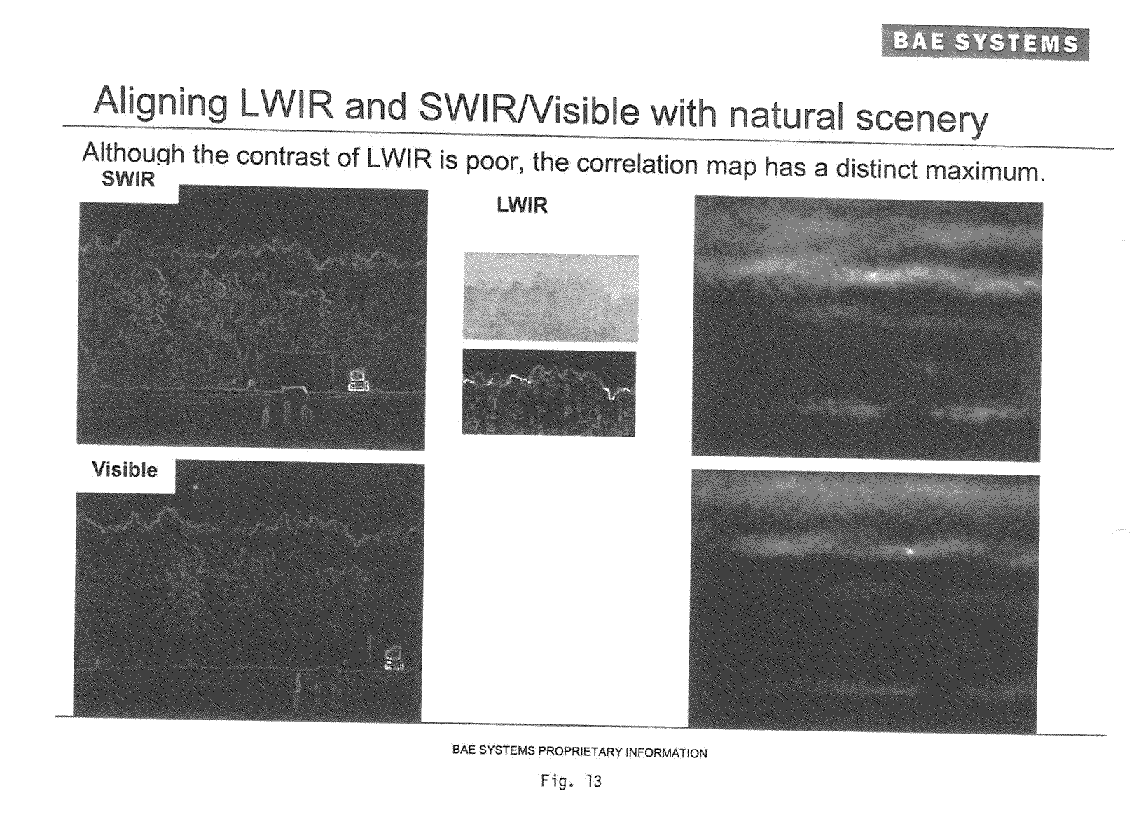

FIG. 13 demonstrates the generation of the Sobels and SWIR, visible and LWIR of the treeline and actually the far right shows the resulting correlation map.

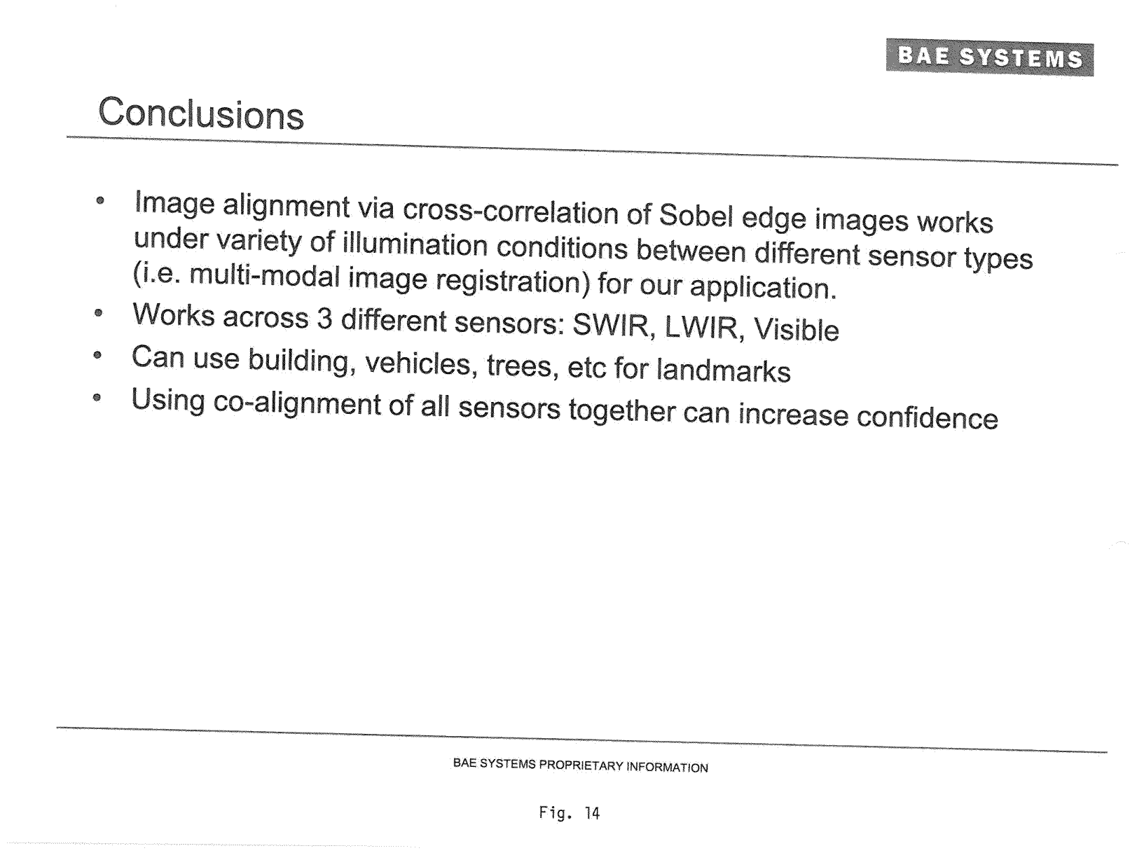

FIG. 14 shows the conclusion we reached in which Sobels can be generated among all the three different bands and can be correlated quite accurately. It is demonstrated that buildings, vehicles, trees, any type of landmarks can be used, and all we need are pictures that have some contrast in it so that co-alignment generated.

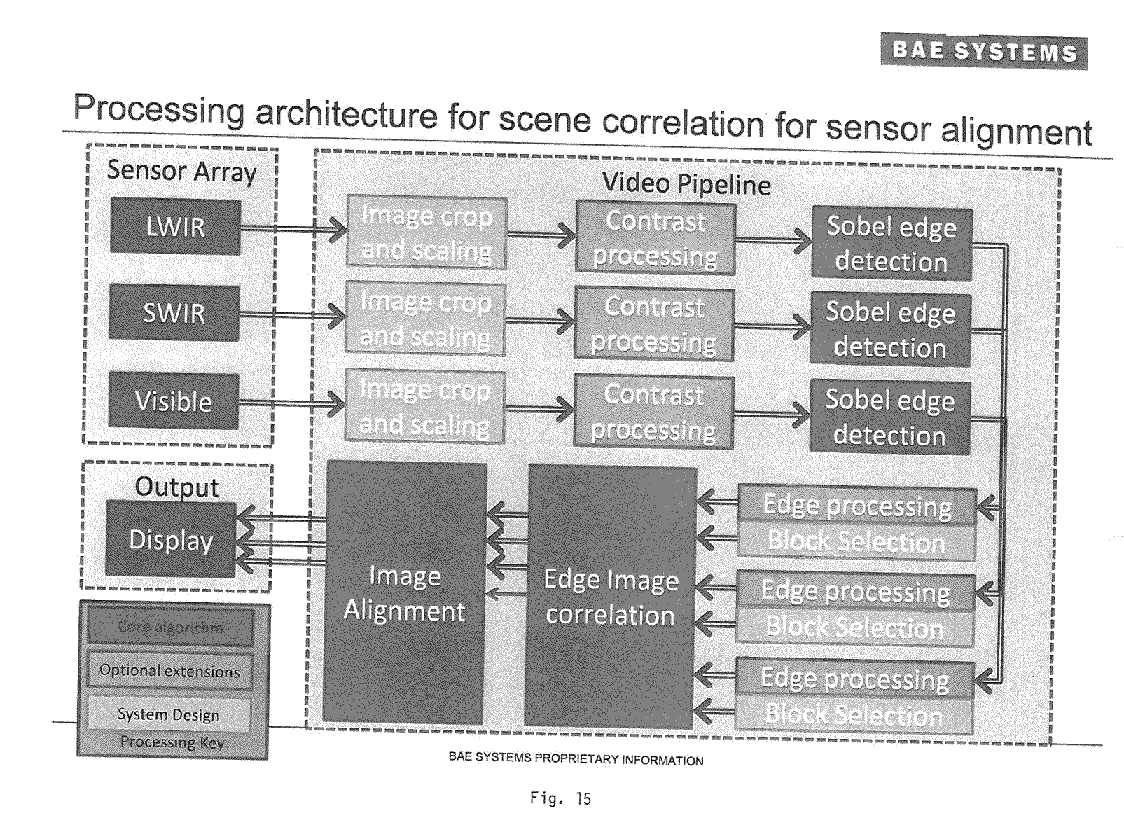

FIG. 15 is a simplified block diagram taking the imagery in from all three arrays showing sensor arrays that can be cropped and scaled and that the scaling is important. It is important to maintain proper scaling of the imagery so that the images can lay on top of each other. The Sobels then can be processed and the correlation between the different camera bands for maximum alignment can be determined. The correlation position represents the offset between the two camera images or the positional tolerance between them. We can then map and can fuse them so that we can do anything at that point based on the result of the correlation.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, hut rather construed in breadth and scope in accordance with the recitation of the appended claims.

What is claimed is:

1. A method for correlating an image to align two sensors comprising the steps of:
centering an imaging unit on a landmark that provides good contrast and distinct edges so as to provide a scene;
taking a snapshot of the scene from both sensors;
applying a Sobel edge filter to the image from both sensors to create two strong edge maps;
cropping a small block of one image centered about the landmark and cross-correlating it on a larger region centered on an expected position of the landmark in the other image; and
from the position of the strongest correlation peak determining the position of the center of the block from the first image, providing the difference in the alignment of the two sensors.

2. The method of claim 1 wherein accuracy is improved by using multiple blocks from the first image and accounting for the corresponding correlation peak strengths.

3. The method of claim 2 wherein the step of using blocks from the second sensor on regions in the first is performed.

4. The method of claim 3 including the additional step of seeing all lasers within a camera band and correlating a laser location relative another band.
